(19) United States
(12) Patent Application Publication
(10) Pub. No.: US 2025/0369557 A1
(43) Pub. Date: Dec. 4, 2025

(54) MULTIFUNCTIONAL CARRIER STRUCTURE

(71) Applicant: OXTI Pte Ltd, Singapore (SG)

(72) Inventor: Chih-Feng Ho, Singapore (SG)

(21) Appl. No.: 18/677,933

(22) Filed: May 30, 2024

(51) Int. Cl. F16M 11/12; F16M 11/04

(52) U.S. Cl. CPC F16M 11/126; F16M 11/046; F16M 2200/08

(57) ABSTRACT

A multifunctional carrier structure of an electronic device is provided, including: an electronic device; an elevation mechanism arranged, at intervals, at one side of the electronic device, where the elevation mechanism includes a main body and an elevating portion, which is arranged on the main body in a manner of being movable upwards and downwards; a rotation mechanism arranged between the electronic device and the elevation mechanism and including a first rotating portion and a second rotating portion, which are rotatably connected to each other, the first rotating portion being connected to the elevating portion, the second rotating portion being connected to the electronic device; and a base connected to the main body of the elevation mechanism. In this way, the electronic device is provided with functions of elevation and rotation and is also provided with a function of fixing on a desktop.

### BACKGROUND OF THE INVENTION

### (a) Technical Field of the Invention

The present invention relates to an electronic device, and more particularly to a multifunctional carrier structure.

### (b) Description of the Prior Art

Supportive stands for use with displays are known, such as Taiwan Utility Model M599368, which discloses a supportive stand including a base, an upright pillar, a hooking member, and a fastening member. The upright pillar is mounted on the base, and the hooking member is connected with the fastening member for combination and fixation to have the supportive stand firmly erected. Further, the upright pillar is provided with a carrying member for supporting a display.

The known supportive stands often use a fixing member (such as a pin, a bolt, and a spring) provided on an upright pillar to adjust a height-wise position of a display. Some implementation, however, must be assisted by additional tools for making adjustment. Further, most of the supportive stands can only be adjusted for the height-wise position of the display. In case that a user attempts to make rotation or adjustment to other angular positions for different conditions of uses, there will be situations where the supportive stands cannot be adjusted for such attempts. As such, there is still room for further improvement.

### SUMMARY OF THE INVENTION

To achieve above purpose, the present invention provides a multifunctional carrier structure, which comprises: an electronic device; an elevation mechanism, which is arranged, at intervals, at one side of the electronic device, the elevation mechanism comprising a main body and an elevating portion, the elevating portion being arranged on the main body in a manner of being movable upwards and downwards; a rotation mechanism, which is arranged between the electronic device and the elevation mechanism, the rotation mechanism comprising a first rotating portion and a second rotating portion, the first rotating portion and the second rotating portion being rotatably connected to each other, the first rotating portion being connected to the elevating portion, the second rotating portion being the electronic device; and a base, which is connected to the main body of the elevation mechanism.

In the above structure, the elevation mechanism further comprises a slide channel, the slide channel being formed in the main body, the elevating portion being received in the slide channel, the elevating portion being movable along the slide channel.

In the above structure, the rotation mechanism further comprises a first rotation axle, the first rotation axle being coupled between the first rotating portion and the second rotating portion, the first rotating portion and the second rotating portion being rotatably connected to each other by means of the first rotation axle.

In the above structure, the rotation mechanism comprises a connecting seat and a second rotation axle, the connecting seat and the second rotation axle being arranged between the second rotating portion and the electronic device, the second rotating portion and the electronic device being rotatably connected by means of the connecting seat and the second rotation axle.

In the above structure, the base comprises a clamping device or a board.

In the above structure, the base comprises a clamping device, the clamping device comprising a clamping body and at least one fastener, the fastener being arranged on the clamping body.

In the above structure, the electronic device comprises a tablet computer, a smart phone, an electronic reader, or a computer display.

In this way, the electronic device so mounted is provided with functions of elevation and rotation, and is also provided with a function of fixing to a desktop, to thereby suit the needs for various ways of use.

### BRIEF DESCRIPTION OF THE DRAWINGS

FIG. 1 is a schematic view showing the present invention.

FIG. 2 is a schematic view showing a portion of the present invention.

FIG. 3 is a schematic view illustrating operation of an elevation mechanism of the present invention.

FIG. 4 is a schematic view illustrating operation of a rotation mechanism of the present invention.

FIG. 5 is a schematic view showing a base of the present invention.

FIG. 6 is a schematic view showing a drive mechanism of the present invention.

FIG. 7 is an exploded view showing the drive mechanism of the present invention.

FIG. 8 is a cross-sectional view showing the drive mechanism of the present invention.

FIG. 9 is a schematic view illustrating operation of the drive mechanism of the present invention.

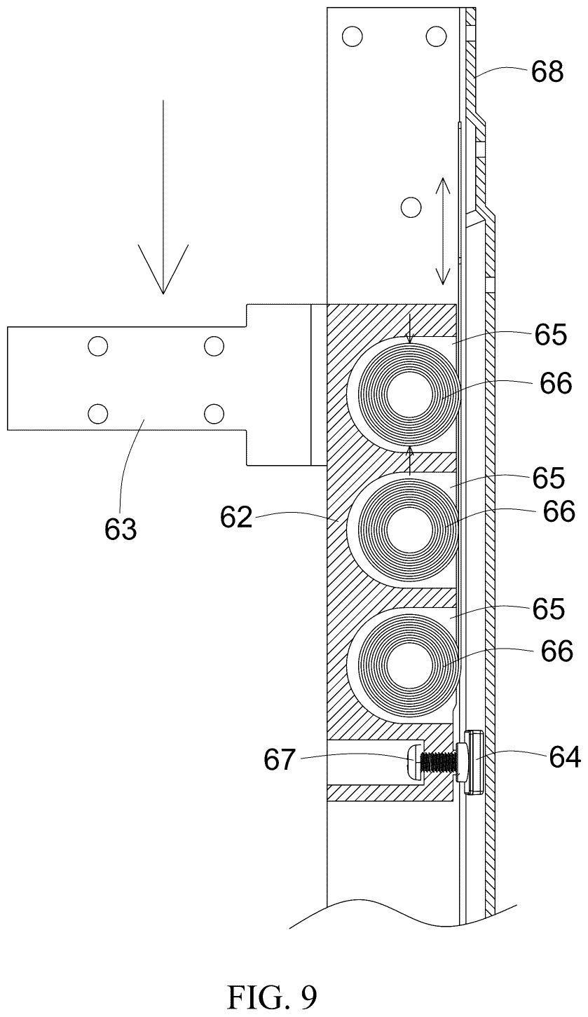

FIG. 10 is a schematic view showing the base of the present invention that is made in the form of a board.

### DETAILED DESCRIPTION OF THE PREFERRED EMBODIMENTS

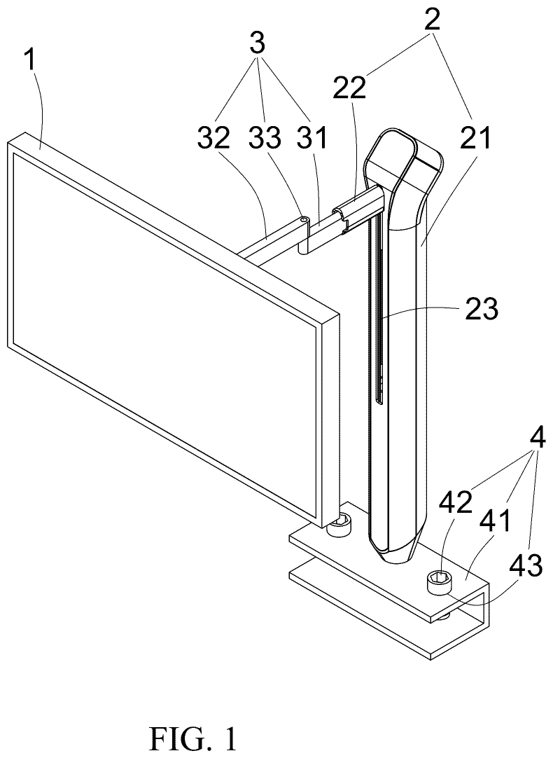

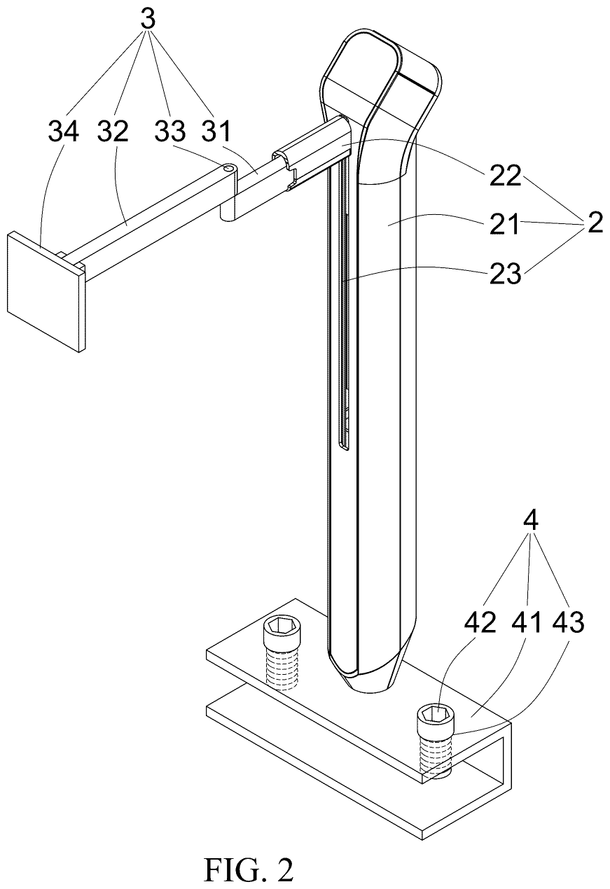

Referring to FIGS. 1 and 2, the present invention provides a multifunctional carrier structure, which comprises: an electronic device 1, an elevation mechanism 2, a rotation mechanism 3, and a base.

The electronic device 1 can be a tablet computer, a smart phone, an electronic reader, or a computer display, but is not limited thereto.

The elevation mechanism 2 is arranged, at intervals, at one side of the electronic device 1. The elevation mechanism 2 comprises a main body 21 and an elevating portion 22. The elevating portion 22 is arranged on the main body 21 in a manner of being movable upwards and downwards. The elevation mechanism 2 further comprises a slide channel 23, and the slide channel 23 is formed in the main body 21. The elevating portion 22 is received in the slide channel 23, and the elevating portion 22 is movable along the slide channel 23.

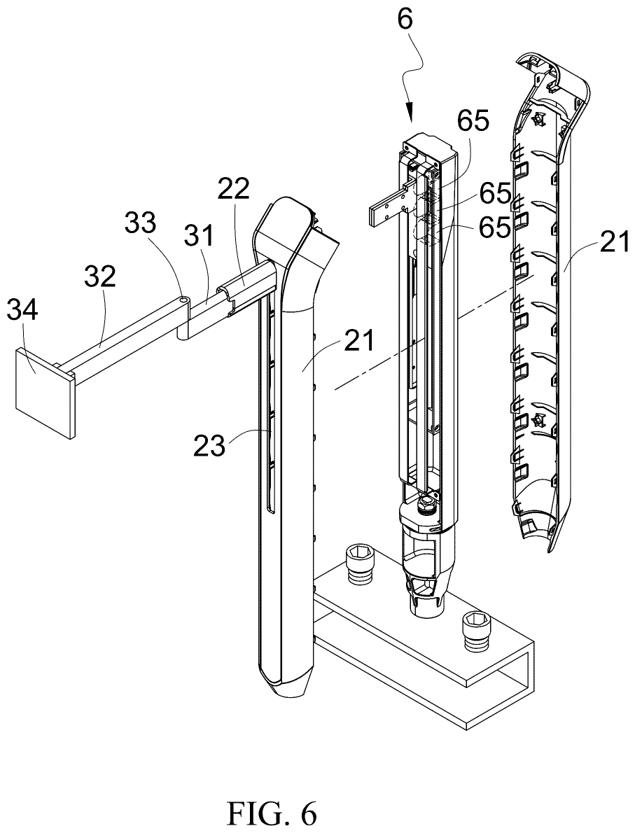

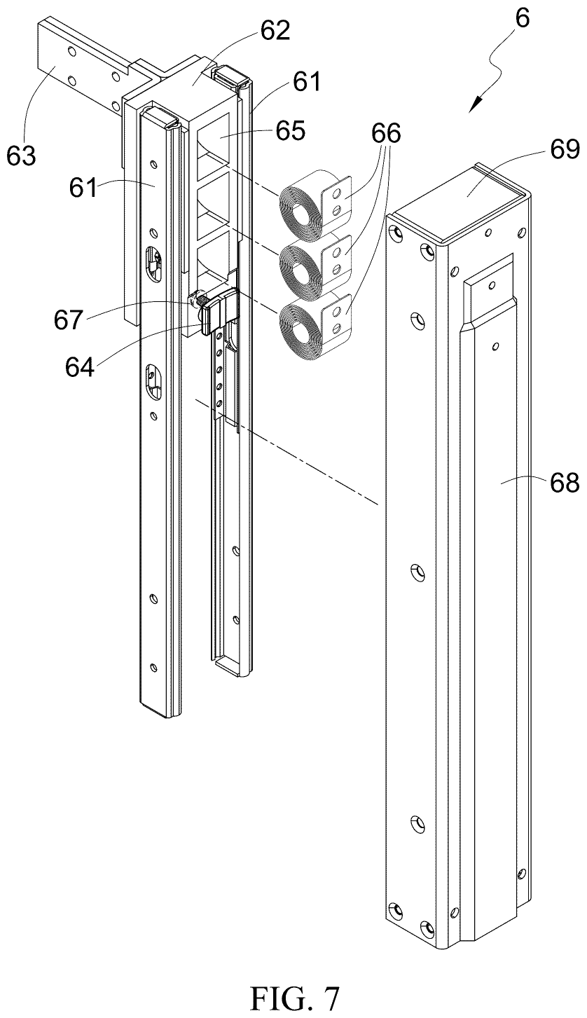

Referring to FIGS. 6 and 7, the main body 21 is provided, in an interior thereof, with a drive mechanism 6. The drive mechanism 6 is operable to drive the elevating portion 22 to move along the slide channel 23 and to position the elevating portion 22. The drive mechanism 6 comprises a pair of guide tracks 61, and a longitudinal moving member 62 is arranged between the guide tracks 61. An extension arm 63 is arranged to extend from one side of the longitudinal moving member 62. The extension arm 63 is combined with the elevating portion 22 of the elevation mechanism 2. Further, a frictional member 64 and a plurality of receiving compartments 65 are arranged on an opposite side of the longitudinal moving member 62. The drive mechanism 6 further comprises a housing 69, and a plurality of elastic members 66 are arranged in the housing 69. The elastic members 66 are respectively received in the receiving compartments 65 of the longitudinal moving member 62 to each provide a spring force. The elastic members 66 can each be a constant-force spring, which is formed by winding a steel belt. After the constant-force spring is stretched flat, the constant-force spring automatically winds back to generate a spring force. The housing 69 is further provided with a frictional track 68, and the frictional track 68 is arranged for contact engagement with the frictional member 64 of the longitudinal moving member 62 to provide an increased frictional force. The longitudinal moving member 62 comprises a frictional force adjusting member 67, and the frictional force adjusting member 67 pushes against the frictional member 64 to adjust the frictional force between the frictional member 64 and the frictional track 68 so as to achieve increasing the frictional force or decreasing the frictional force.

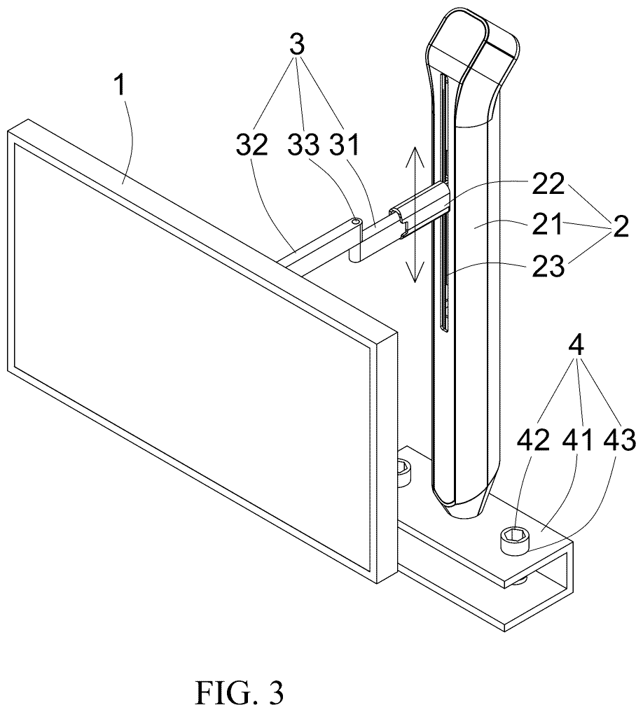

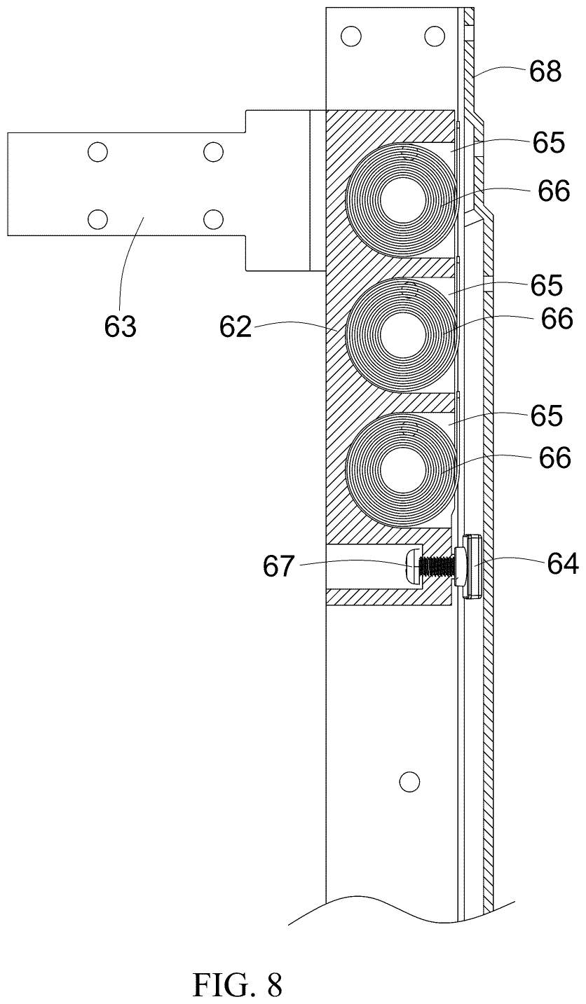

Referring jointly to FIGS. 3, 7, and 8, when a user pulls and thus moves the electronic device 1, the electronic device 1 causes the elevating portion 22 of the elevation mechanism 2 to move along the slide channel 23, and the elevating portion 22 drives the longitudinal moving member 62 to move therewith, so as to make the longitudinal moving member 62 moving along the guide tracks 61. The movement of the longitudinal moving member 62 causes the elastic members 66 to stretch out and become flat to generate a spring force. The spring force of the elastic members 66 is made corresponding to the weight of the electronic device 1, so that the spring force of the elastic members 66 counteracts the weight of the electronic device 1, preventing the electronic device 1 from falling down. At the same time, the frictional member 64 of the longitudinal moving member 62 is in contact engagement with the frictional track 68, and the frictional force induced by the frictional track 68 provides an effect of cushioning to prevent the electronic device 1 from moving upwards/downwards at an excessively large speed, and as such, the user may pull the electronic device 1 upwards or downwards to fulfill the function of elevation.

Continuously referring to FIGS. 1 and 2, the rotation mechanism 3 is arranged between the electronic device 1 and the elevation mechanism 2. The rotation mechanism 3 comprises a first rotating portion 31 and a second rotating portion 32. The first rotating portion 31 and the second rotating portion 32 are rotatably connected to each other. The first rotating portion 31 is connected to the elevating portion 22. The second rotating portion 32 is connected to the electronic device 1. The rotation mechanism 3 may further comprise a first rotation axle 33, and the first rotation axle 33 is coupled between the first rotating portion 31 and the second rotating portion 32. The first rotating portion 31 and the second rotating portion 32 are rotatably connected to each other by means of the first rotation axle 33.

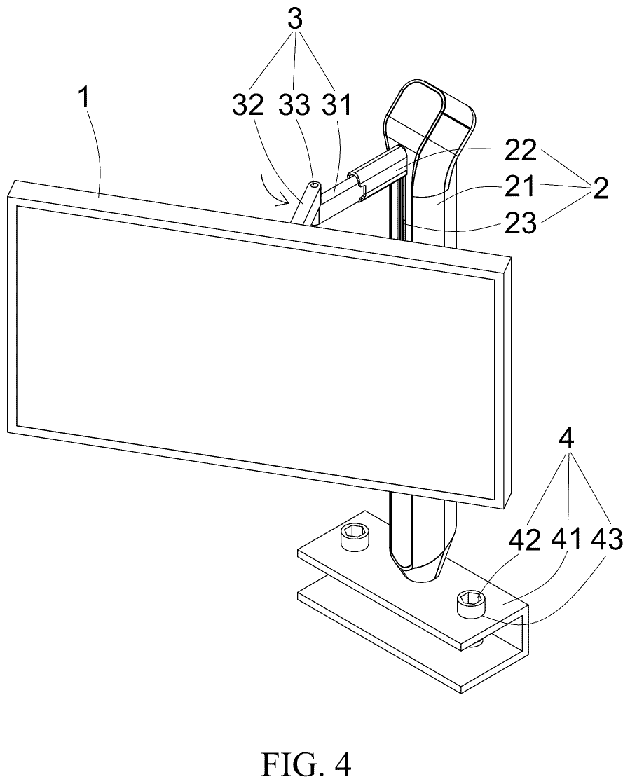

Referring to FIG. 4, when the user rotates the electronic device 1 leftwards and rightwards, the electronic device 1 causes the second rotating portion 32 to rotate leftwards and rightwards. Further, due to the first rotation axle 33 being coupled between the first rotating portion 31 and the second rotating portion 32, the second rotating portion 32 is rotatable relative to the first rotating portion 31 to fulfill the function of rotation.

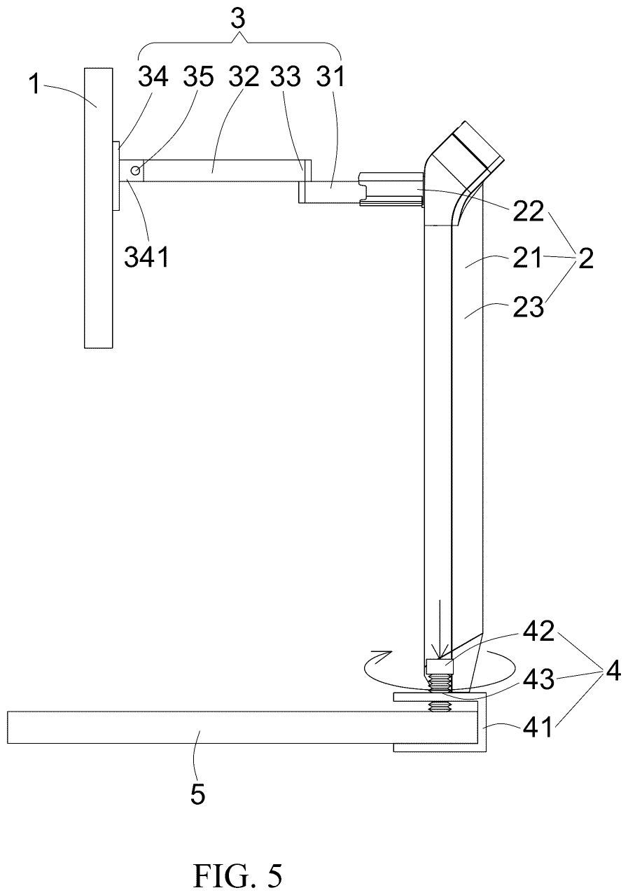

Referring to FIG. 5, the rotation mechanism 3 may further comprise a connecting seat 34 and a second rotation axle 35. The connecting seat 34 and the second rotation axle 35 are arranged between the second rotating portion 32 and the electronic device 1. A rotating connection is formed between the second rotating portion 32 and the electronic device 1 by means of the connecting seat 34 and the second rotation axle 35. Speaking in details, the connecting seat 34 is fixedly connected with the electronic device 1. For example, the connecting seat 34 may be formed with fastening holes, and the electronic device 1 is fastened to the fastening holes of the connecting seat 34. The connecting seat 34 is further provided with a sleeve 341 extending therefrom. The sleeve 341 is formed with an axle hole for receiving insertion of the second rotation axle 35. The second rotation axle 35 is arranged on the second rotating portion 32, and the second rotation axle 35 is inserted into the axle hole of the sleeve 341 to have the connecting seat 34 rotatable relative to the second rotating portion 32. As such, the user may rotate the electronic device 1 upwards and downwards to change a tilting angle of the electronic device 1 as desired.

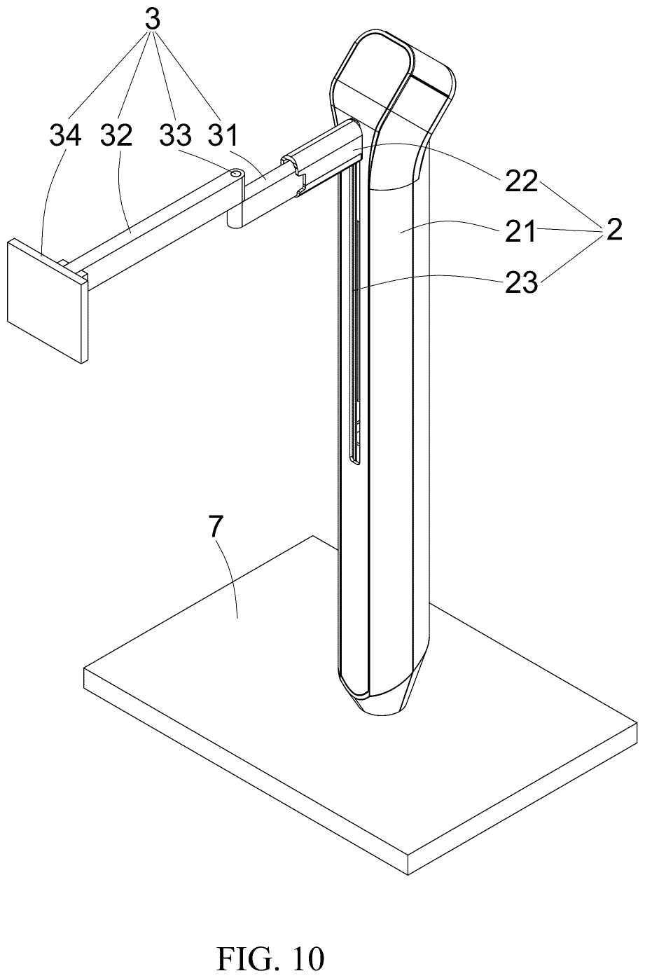

Referring to FIGS. 1 and 10, the base is connected to the main body 21 of the elevation mechanism 2. The base can be a clamping device 4 (shown in FIG. 1) or a board 7 (shown in FIG. 10). Speaking more specifically, in FIGS. 1 and 2, the clamping device 4 comprise a clamping body 41 and at least one fastener 42. The fastener 42 is arranged on the clamping body 41. The clamping body 41 is connected to the main body 21 of the elevation mechanism 2. Further, the clamping body 41 is made in the form of a frame. The clamping body 41 is formed with a threaded hole 43, and the fastener 42 comprises a screw. The screw penetrates into the threaded hole 43. Referring to FIG. 5, in this way, the user may use the clamping device 4 to clamp on a desktop 5, and the user may then penetrate the fastener 42 through the threaded hole 43 to have the fastener 42 abutting against the desktop 5, so as to make the clamping device 4 more firmly secured on the desktop 5 to fulfill the function of fixing to the desktop 5. In FIG. 10, the base comprises a board 7, which, although not fulfilling the function of fixing, is easy to move, and the user may make selection according to a practical need.

As such, the electronic device 1 mounted in this way is provided with functions of elevation and rotation, and is also provided with a function of fixing to a desktop 5, to thereby suit needs for various ways of use.

I CLAIM:

1. A multifunctional carrier structure, comprising:
an electronic device;
an elevation mechanism, which is arranged, at intervals, at one side of the electronic device, the elevation mechanism comprising a main body and an elevating portion, the elevating portion being arranged on the main body in a manner of being movable upwards and downwards;
a rotation mechanism, which is arranged between the electronic device and the elevation mechanism, the rotation mechanism comprising a first rotating portion and a second rotating portion, the first rotating portion and the second rotating portion being rotatably connected to each other, the first rotating portion being connected to the elevating portion, the second rotating portion being connected to the electronic device; and
a base, which is connected to the main body of the elevation mechanism.

2. The multifunctional carrier structure according to claim 1, wherein the elevation mechanism further comprises a slide channel, the slide channel being formed in the main body, the elevating portion being received in the slide channel, the elevating portion being movable along the slide channel.

3. The multifunctional carrier structure according to claim 1, wherein the rotation mechanism further comprises a first rotation axle, the first rotation axle being coupled between the first rotating portion and the second rotating portion, the first rotating portion and the second rotating portion being rotatably connected to each other by means of the first rotation axle.

4. The multifunctional carrier structure according to claim 1, wherein the rotation mechanism comprises a connecting seat and a second rotation axle, the connecting seat and the second rotation axle being arranged between the second rotating portion and the electronic device, the second rotating portion and the electronic device being rotatably connected by means of the connecting seat and the second rotation axle.

5. The multifunctional carrier structure according to claim 1, wherein the base comprises a clamping device or a board.

6. The multifunctional carrier structure according to claim 1, wherein the base comprises a clamping device, the clamping device comprising a clamping body and at least one fastener, the fastener being arranged on the clamping body.

7. The multifunctional carrier structure according to claim 1, wherein the electronic device comprises a tablet computer, a smart phone, an electronic reader, or a computer display.
